(19) United States
(12) Patent Application Publication
(10) Pub. No.: US 2003/0006142 A1
(43) Pub. Date: Jan. 9, 2003

(54) Radial electrophoresis apparatus and method

(76) Inventors: Chenicheri Hariharan Nair, Old Greenwich, CT (US); Philip John Roeth, Castle Hills (AU)

Correspondence Address: James D. Jacobs, Esq., Baker & McKenzie, 805 Third Avenue, New York, NY, 10022, US

(21) Appl. No.: 10/029,014

(22) Filed: Dec. 21, 2001

(30) Foreign Application Priority Data
Dec. 21, 2000 (AU) PR2223

(51) Int. Cl. B01D 61/42

(52) U.S. Cl. 204/631; 204/521

(57) ABSTRACT

The present invention is directed to an electrophoresis apparatus comprising: an inner electrode positioned in an inner electrolyte zone; a substantially non-planar outer electrode positioned in an outer electrolyte zone, wherein the electrodes are positioned so as to be adapted to generate a radial electric field in an electric field area therebetween upon application of an electric potential between the inner and outer electrodes; first and second substantially non-planar membranes disposed in the electric field area and forming a first interstitial volume; means adapted to communicate fluids to the inner electrolyte zone, the outer electrolyte zone, and the first interstitial volume; means adapted to provide a sample constituent to the first interstitial volume; and means adapted to apply an electric potential across at least the electric field area wherein upon application of the electric potential at least one component in the sample constituent is caused to move through at least one membrane to an adjacent electrolyte zone.

### BACKGROUND OF THE INVENTION

The present invention relates to apparatus and method for electrophoretic separation and treatment of samples.

A variety of electrophoretic techniques have been developed for the processing of charged macromolecules with the most successful being polyacrylamide gel electrophoresis, isoelectric focusing and capillary electrophoresis. Attempts to translate this resolution to a preparative scale have been less successful because the increasing volume of the porous matrix in a larger apparatus makes heat removal more difficult. Nevertheless, partial success has been achieved for some preparative systems including free flow electrophoresis, recycling isoelectric focusing, multi-compartment electrolyzer, and conventional gel preparative systems. Although there are a variety of techniques for processing charged molecules, often the presence of salts or other compounds in the preparation can hinder the separation or, alternatively, high concentration of salts may be present in the end product.

Unfortunately, many of the techniques presently available result in loss of some of the macromolecules/compounds, inactivation of the macromolecules/compounds, or dilution of the macromolecule/compound preparation.

The present inventors have now developed a new apparatus which is adaptable for several different separation modes and can be used for large scale separations.

### SUMMARY OF THE INVENTION

In accordance with the present invention, there is provided an apparatus which is adaptable for several different separation modes and can be used for large scale separations.

Further, in accordance with the present invention, there is provided an electrophoresis apparatus comprising:

an inner electrode positioned in an inner electrolyte zone;

a substantially non-planar outer electrode positioned in an outer electrolyte zone, wherein the outer electrode in the outer electrolyte zone is disposed relative to the inner electrode in the inner electrolyte zone so as to be adapted to generate a radial electric field in an electric field area therebetween upon application of a selected electric potential between the inner and outer electrodes;

a first substantially non-planar membrane disposed in the electric field area;

a second substantially non-planar membrane disposed between the inner electrolyte zone and the first membrane so as to define a first interstitial volume therebetween, wherein the first interstitial volume is separated from the inner and outer electrolyte zones by the first and second membranes;

means adapted to communicate fluids to the inner electrolyte zone, the outer electrolyte zone, and the first interstitial volume; and

means adapted to provide a sample constituent to the first interstitial volume, wherein upon application of the electric potential at least one component in the sample constituent is caused to move through at least one membrane to an adjacent electrolyte zone.

The apparatus is suitably comprised of means adapted to receive a selected voltage and means adopted to apply an electric potential corresponding thereto across at least the electric field area. In this form, a power supply is provided or integrated with the apparatus. Typically, the apparatus is connected to an external power supply by any suitable electrical connector means.

The apparatus is suitably comprised of an elongated housing having first and second opposing ends and an interior portion containing the inner and outer electrodes and the membrane; a first manifold positioned at the first opposing end of the housing, the first manifold having means adapted to communicate at least one associated fluid with at least one of the electrolyte zones and the interstitial volume; and a second manifold positioned at the second opposing end of the housing, the second manifold having means adapted to communicate at least one associated fluid with at least one of the electrolyte zones and the interstitial volume.

The housing can be substantially cylindrical so as to accommodate the electrodes and membranes therein. When assembled, the housing and manifolds seal the electrolyte zones and interstitial volumes. Preferably, the housing is electrically insulated or made of non-conducting material to ensure that the apparatus is safe during use, and that there is no short circuit or inefficient leakage of current by passing the interstitial volume(s). The housing suitably further contains electrical connectors for connecting power to the respective inner and outer electrodes.

Still further, in accordance with the present invention, there is provided an electrophoresis apparatus comprising:

an inner electrode positioned in an inner electrolyte zone;

a substantially non-planar outer electrode positioned in an outer electrolyte zone, wherein the outer electrode in the outer electrolyte zone is disposed relative to the inner electrode in the inner electrolyte zone so as to be adapted to generate a radial electric field in an electric field area therebetween upon application of an electric potential between the inner and outer electrodes;

a first substantially non-planar membrane disposed in the electric field area;

a second substantially non-planar membrane disposed between the inner electrolyte zone and the first membrane so as to define a first interstitial volume therebetween;

a third substantially non-planar membrane disposed between the outer electrolyte zone and the first membrane so as to define a second interstitial volume therebetween, wherein the first interstitial volume is separated from the inner electrolyte zone by the second membrane and the second interstitial volume is separated from the outer electrolyte zone by the third membrane;

means adapted to communicate fluids to the inner electrolyte zone, the outer electrolyte zone, the first interstitial volume and the second interstitial volumes; and

means adapted to provide a sample constituent to at least one of the interstitial volumes, wherein upon application of the electric potential at least one component in the sample constituent is caused to move through at least one membrane to an adjacent electrolyte zone or interstitial volume.

The apparatus is suitably comprised of means adapted to receive a selected voltage and means adapted to apply an electric potential corresponding thereto across at least the electric field area. In this form, a power supply is provided or integrated with the apparatus. Typically, the apparatus is connected to an external power supply by any suitable electrical connector means.

The apparatus is suitably comprised of an elongated housing having first and second opposing ends and an interior portion containing the inner and outer electrodes and the membrane; a first manifold positioned at the first opposing end of the housing, the first manifold having means adapted to communicate at least one associated fluid with at least one of the electrolyte zones and the interstitial volume; and a second manifold positioned at the second opposing end of the housing, the second manifold having means adapted to communicate at least one associated fluid with at least one of the electrolyte zones and the interstitial volume.

The housing can be substantially cylindrical so as to accommodate the electrodes and membranes therein. When assembled, the housing and manifolds seal the electrolyte zones and interstitial volumes. Preferably, the housing is electrically insulated or made of non-conducting material to ensure that the apparatus is safe during use, and that there is no short circuit or inefficient leakage of current by passing the interstitial volume(s). The housing suitably further contains electrical connectors for connecting power to the respective inner and outer electrodes.

Still further, in accordance with the present invention, there is provided an electrophoresis apparatus comprising:

an inner electrode positioned in an inner electrolyte zone;

a substantially non-planar outer electrode positioned in an outer electrolyte zone, wherein the outer electrode in the outer electrolyte zone is disposed relative to the inner electrode in the inner electrolyte zone so as to be adapted to generate a radial electric field in an electric field area therebetween upon application of a selected electric potential between the inner and outer electrodes;

at least one substantially tubular membrane disposed radially outward of an axis in the electric field area, wherein the inner electrode disposed generally along such axis, and wherein the tubular membrane has an exterior surface and an interior surface and the interior surface of the tubular membrane forms at least a first interstitial volume

means adapted to communicate fluids to the inner electrolyte zone, the outer electrolyte zone, and the first interstitial volume; and

means adapted to provide a sample constituent to at least the first interstitial volume, wherein upon application of the electric potential at least one component in the sample constituent is caused to move through at least one membrane to an adjacent electrolyte zone.

In a preferred embodiment, the apparatus is suitably further comprised of a plurality of substantially tubular membranes disposed radially outward of an axis in the electric field area, wherein the inner electrode disposed generally along such axis, and wherein the tubular membranes have an exterior surface and an interior surface and the interior surface of each tubular membrane forms an interstitial volume. Fluids are communicated to the interstitial volumes wherein at least one of the fluids contains a sample constituent. Upon the application of a selected electric potential, at least one component in the sample constituent is caused to move through at least one membrane to an adjacent electrolyte zone.

The apparatus is suitably comprised of means adapted to receive a selected voltage and means adopted to apply an electric potential corresponding thereto across at least the electric field area. In this form, a power supply is provided or integrated with the apparatus. Typically, the apparatus is connected to an external power supply by any suitable electrical connector means.

The apparatus is suitably comprised of an elongated housing having first and second opposing ends and an interior portion containing the inner and outer electrodes and the membrane; a first manifold positioned at the first opposing end of the housing, the first manifold having means adapted to communicate at least one associated fluid with at least one of the electrolyte zones and the interstitial volume; and a second manifold positioned at the second opposing end of the housing, the second manifold having means adapted to communicate at least one associated fluid with at least one of the electrolyte zones and the interstitial volume.

The housing can be substantially cylindrical so as to accommodate the electrodes and membranes therein. When assembled, the housing and manifolds seal the electrolyte zones and interstitial volumes. Preferably, the housing is electrically insulated or made of non-conducting material to ensure that the apparatus is safe during use, and that there is no short circuit or inefficient leakage of current by passing the interstitial volume(s). The housing suitably further contains electrical connectors for connecting power to the respective inner and outer electrodes.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia before the priority date of each claim of this application.

These and other aspects of the invention will be understood by one skilled in the art upon the reading and understanding of the specification.

### BRIEF DESCRIPTION OF DRAWINGS

FIG. 1 shows a schematic cross-sectional view of two forms of an apparatus according to the present invention being substantially circular in cross section. FIG. 1A depicts an apparatus having three coaxial membranes positioned between two electrodes. FIG. 1B depicts an apparatus having two coaxial membranes positioned between two electrodes.

FIG. 2 shows a view of an assembled apparatus as shown in FIG. 1A.

FIG. 3 shows a view of an arrangement of a manifold for use in the apparatus depicted in FIG. 2.

FIG. 4 shows a further example of an apparatus according to the present invention having multiple separation tubes or fibers. FIG. 4A is an exploded view of the apparatus and FIG. 4B is an assembled view of the hollow fiber apparatus.

### DETAILED DESCRIPTION OF THE INVENTION

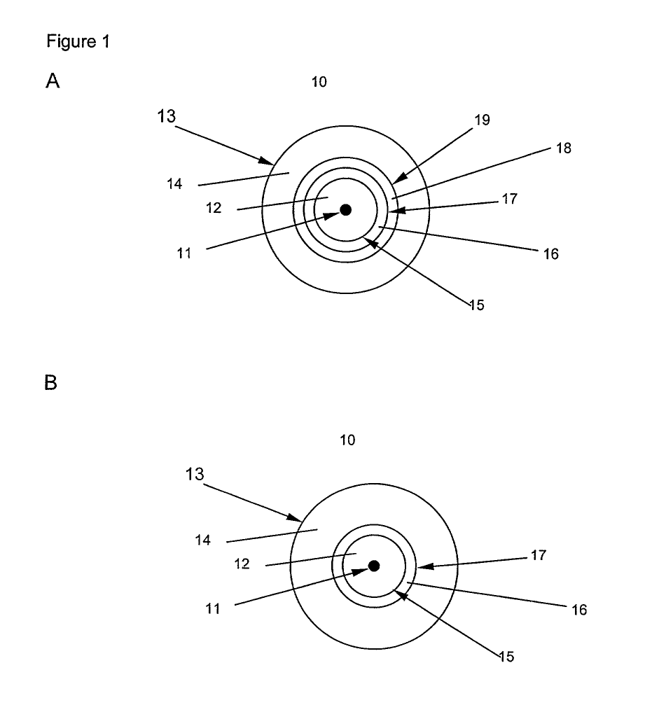

A general example of an apparatus according to one embodiment of the present invention is shown in FIG. 1A. The apparatus 10 includes an inner electrode 11 formed of a wire material positioned centrally within the apparatus 10. The inner electrode 11 is surrounded by a first non-planar membrane 15 (inner containment membrane) which forms an inner electrolyte zone 12 in which the inner electrode 11 is positioned. A second non-planar membrane 17 is positioned around the first membrane 15 forming a first interstitial volume 16. A third membrane 19 is positioned around the second membrane 17 forming a second interstitial volume 18. The third non-planar membrane 19 can be used for containment of separated compounds from the first interstitial volume 16. An outer electrode 13 is positioned outside the third membrane 19 in an outer electrolyte zone 14. The components of the apparatus are coaxially positioned about the inner electrode 11.

The first, second and third membranes 15, 17, 19 define four areas 12, 14, 16, 18 through which fluid (water, aqueous buffer, organic solvent etc.) can be passed, preferably by pumping to control the flow.

The outer electrolyte zone 14 outside the third membrane 19 contains an appropriate solvent for the extraction procedure, for example an electrophoresis buffer. The concentration, constituents and pH of the solvent can be selected to control the net charge on a molecule of interest.

The second non-planar membrane 17 can have a suitable pore size to allow passage of molecules of interest (sieving membrane) and is positioned around the first membrane 15 forming a first interstitial zone 16 to which a sample is placed.

The first interstitial zone 16 can contain the sample constituent from which individual compounds are to be separated or treated. The second interstitial volume 18 initially is filled with appropriate solvent, and serves as the location to where one or more compounds of interest would be transferred from the sample constituent in the first interstitial volume 16. It will be appreciated that a sample can be provided in the second interstitial volume 18 and compound(s) of interest can be moved into the first interstitial volume 16 or adjacent electrolyte zone.

The inner electrolyte zone 12 inside the first membrane 15 is filled with a suitable solvent, which may be the same as that in the outer electrolyte zone 14, or may be different to create solvent gradients across the electrophoretic apparatus 10.

Sample containing the compound or molecule of interest is passed through the first interstitial volume at a set flow rate and an electrical potential applied between the inner and outer electrodes causing the electrophoretic migration of charged molecules to the electrode carrying opposite charge.

Through the correct choice of solvent conditions and molecular weight cut-off/pore size of the membranes 15, 17, 19, a molecule of interest would be transferred from the sample to the second interstitial volume 18 or one of the electrolyte zones.

The apparatus according to another embodiment of the present invention is shown in FIG. 1B. This apparatus can be made with a similar configuration as the apparatus shown in FIG. 1A but not having a third membrane. In this form, the apparatus 10 includes an inner electrode 11 formed of a wire material positioned centrally within the apparatus 10. The inner electrode 11 is surrounded by a first membrane 15 which forms an inner electrolyte zone 12 in which the inner electrode 11 is positioned. A second non-planar membrane 17 of a suitable pore size to allow passage of molecules of interest is positioned around the first membrane 15 forming a first interstitial zone 16. An outer electrode 13 is positioned outside the second membrane 17 in an outer electrolyte zone 14. The components of the apparatus are coaxially positioned about the inner electrode 11.

The first and second membranes 15, 17 define three areas 12, 14, 16 through which fluid (water, aqueous buffer, organic solvent etc.) can be passed, preferably by pumping to control the flow.

The apparatus can be used for charged-based separations, size-based separations, isoelectric separations, de-salting or concentration depending on the types of membranes used.

In a further preferred form, there is provided a plurality of non-planar membranes positioned between the inner and outer electrodes forming a plurality of interstitial volumes in the electric field area.

Preferably, at least some of the membranes are electrophoresis separation membranes having defined pore sizes. One or more membranes can be a charged or electro-endo-osmosis membranes which control substantial bulk movement of fluid under the influence of a radial electric field.

The electrophoresis separation membranes are preferably made from polyacrylamide and have a molecular mass cut-off of at least about 1 kDa. The choice of the molecular mass cut-off of a membrane will depend on the sample being processed, the other molecules in the sample mixture, and the type of separation carried out.

The charged or electro-endo-osmotic membrane, if used, is preferably a cellulose tri-acetate membrane (CTM). It will be appreciated that the charged membrane can be formed from any other suitable membrane material such as polyvinyl alcohol (PVA1). The present inventors have found that a CTM having a nominal molecular mass cut-off of 5, 10 or 20 kDa is particularly suitable for use in the apparatus.

One or more of the membranes can also be formed to act as an isoelectric or amphoteric membrane containing a defined charge. This arrangement allows isoelectric separations of components in samples.

The membranes may be formed as a multilayer or sandwich arrangement. The thickness of the membranes can have an effect on the separation or movement of compounds. It has been found that the thinner the membrane, faster and more efficient movement of components in a sample occurs.

The membrane positioned between the inner electrolyte zone and the first interstitial volume and between the second interstitial volume adjacent the outer electrolyte zone can have the same molecular mass cut-off or have different cut-offs therefore forming an asymmetrical arrangement.

Preferably, buffer/electrolyte solution is caused to flow through the respective inner and outer electrolyte zones to form streams. Similarly, sample and/or buffer is caused to flow through the interstitial volumes to form streams therethrough. This allows greater throughput of buffer/sample during electrophoresis which can greatly enhance the rate of transfer of selected components in the sample. The arrangement of the apparatus allows the possibility of scale up for commercial separation applications.

Flow rates of buffer/electrolyte solution/sample in the electrolyte zones and interstitial volumes can have an influence on the separation of compounds. Rates of milliliters per minute up to liters per minute can be used depending on the configuration of the apparatus and the sample to be separated.

The temperature of buffer/electrolyte in the electrolyte zones and solutions in the interstitial volumes can be controlled by a suitable cooling/heating means. The apparatus may also be positioned in a controlled-temperature environment to maintain a desired temperature during removal of the salts or the purification of compounds.

The apparatus may have its own power supply or can be connected to an external power supply.

In one preferred embodiment, the electrodes are made of titanium mesh coated with platinum. As the outer electrode is generally non-planar and preferably positioned generally coaxial to the inner or central electrode, it will be appreciated that any suitable formable material can be used for the electrode.

The distance between the electrodes can have an effect on the separation or movement of compounds through the membranes. It has been found that the shorter the distance between the electrodes, the faster the electrophoretic movement of compounds.

Voltage and/or current applied can vary depending on the separation. Typically up to about 500 volts are suitably used but choice of voltage will depend on the configuration of the apparatus, buffers and the sample to be separated or treated.

The membranes are any non-planar shape such as dish, u-shaped, cone, oval, circular or cylindrical. In one preferred form, the membranes are generally circular in cross-section positioned around the inner electrode. Thus, the apparatus is in the form of a cylindrical or tube arrangement positioned around the inner or central electrode. In this form, the outer electrode is also generally circular in cross-section such that when a radial electric field is applied between the electrodes, charged molecules can be caused to move through a membrane in 360° direction.

In one preferred form, at least one interstitial volume positioned between the two electrodes can be rotated axially providing a centrifugal force to material in the volume. In this form, it is possible to separate materials by electrophoresis and centrifugation.

In another form, the membranes are tubular in shape and several sets of membranes are positioned adjacent the outer electrolyte zone. This would be in the form of a hollow fiber configuration where each membrane tube forms an interstitial volume.

An advantage of the apparatus according to the present invention is that the surface area of the membranes is significantly larger than an apparatus with a series of planar membranes where the electromotive force is applied in only one direction.

The apparatus may also further include buffer/electrolyte reservoir(s) for passing buffer or electrolyte to the inner and outer electrolyte zones, sample and separation reservoirs for passing sample and collecting separated components to and from the respective interstitial volumes.

The sample may be any sample and the component may be a compound capable of being caused to move through a membrane under the influence of an electric potential. The method can also be used to de-salt samples by using an apparatus that only contains one interstitial volume positioned between the inner and outer electrolyte zones.

It will be appreciated that due to the relative volumes of the first (inner) and second (outer) interstitial volumes, a greater concentration of a product compound will be achieved if the apparatus is configured to allow collection of the product compound from the first (inner) interstitial volume. Sample may be applied to any or all of the interstitial volumes.

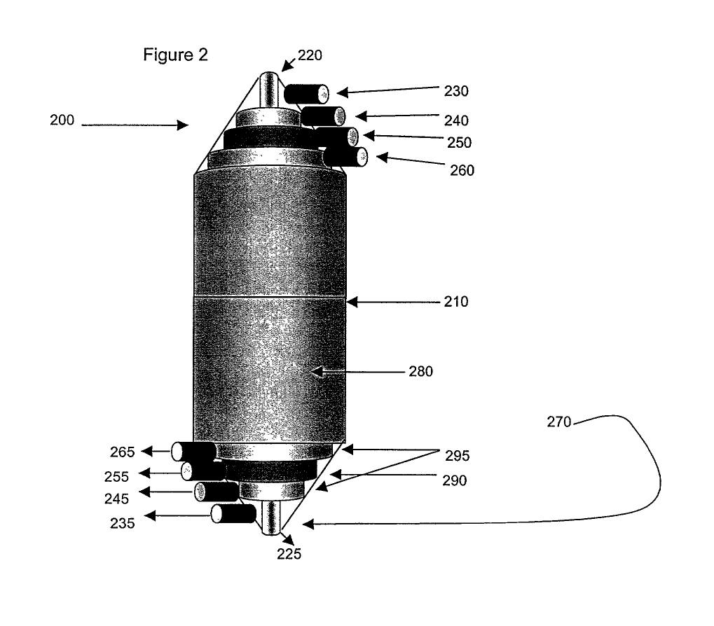

An arrangement of a radial electrophoresis apparatus comprising three membranes is shown in FIG. 2. The apparatus 200 comprises a cylindrical housing 210 having a first manifold 220 positioned at the top of the housing 210. The first manifold 220 includes inlet means 230 for providing buffer or electrolyte to the inner electrolyte zone. Inlet means 240 provides sample or buffer to the first interstitial volume and inlet means 250 is connected to the second interstitial volume for providing sample or buffer thereto. Inlet means 260 provides buffer or electrolyte to the outer electrolyte zone where the outer electrode is housed. Similarly, the apparatus 200 contains a second manifold 225 positioned at the other end of the housing 210. The second manifold 225 contains outlet means 235 for passing buffer or electrolyte out of the inner electrolyte zone. Outlet means 245 and 255 are provided for passing treated sample or buffer out of the first and second interstitial volumes, respectively. Outlet means 265 allows the movement of buffer or electrolyte out of the outer electrolyte zone.

In order to provide electrical connection to the apparatus 200, the first manifold contains electrical connector 270 which is connected to the inner electrode. Electrical connector 280 is used to provide electrical connection to the outer electrode which is incorporated within the outer housing 210. The first (sieving) membrane 290 is located between the inner and outer electrodes, while containment membranes 295 are placed between the first membrane and the inner and outer electrodes respectively, defining the inner and outer interstitial volumes.

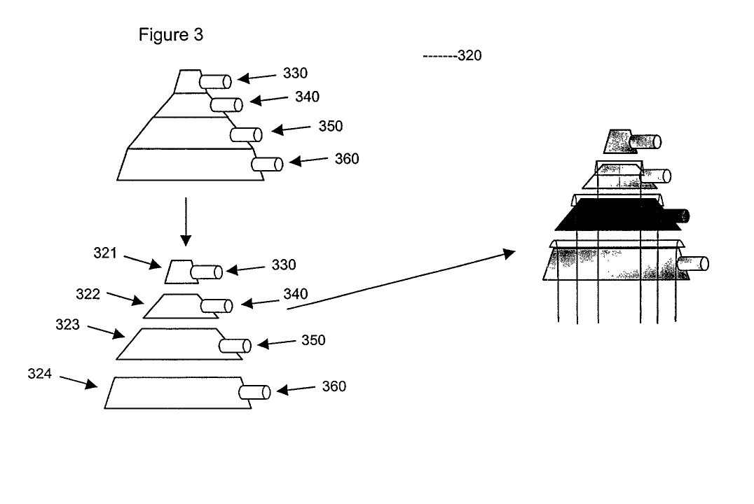

FIG. 3 shows a schematic representation of a first manifold 320 for use in the apparatus shown in FIG. 2. The first manifold 320 is in modular form comprising four components 321, 322, 323, 324 which assist in the formation of the inner electrolyte zone, the first interstitial volume, the second interstitial volume and the outer electrolyte zone, respectively. Each modular component 321, 322, 323, 324 contains a respective inlet means 330, 340, 350, 360 for providing buffer, electrolyte or sample to the respective electrolyte zones or interstitial volumes. The modular upper manifold 320 also provides locating means for the first, second and third membranes. The membranes are positioned within the components 321, 322, 323, 324 of the first manifold 320 so as to locate the membranes which provide the required zones or volumes therebetween.

A similar second manifold is provided for the other end of the housing and has corresponding components. One or both manifolds also provide an electrical connection to the inner electrode.

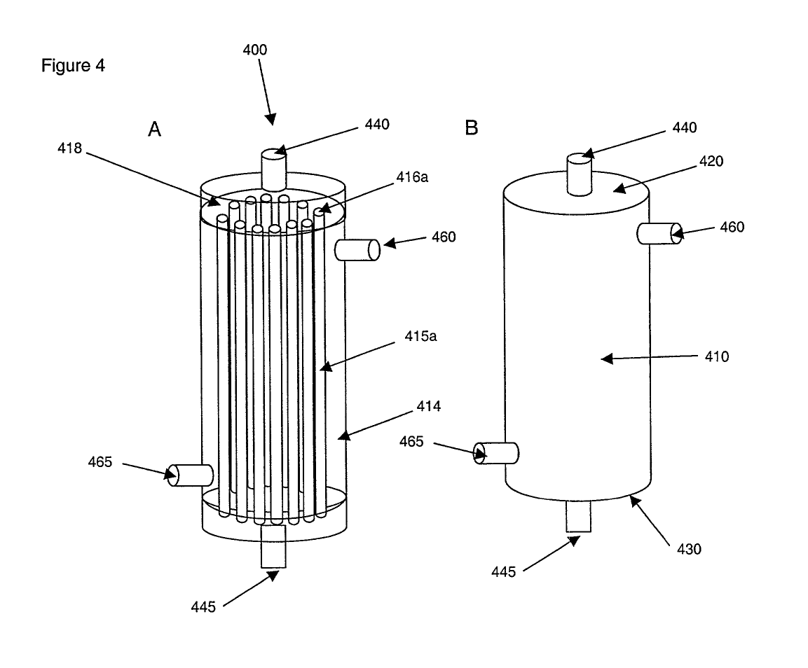

FIG. 4 shows an alternate configuration of electrophoresis apparatus according to the present invention in the form of a hollow fiber configuration. FIG. 4A shows the components of the apparatus 400 having a plurality of substantially tubular membranes forming hollow fibers 415a. The tubular membranes have an exterior surface and an interior surface. The interior surface of each tubular membranes encompasses a luminal space 416a forming an interstitial volume. Each hollow fiber membrane 415a is positioned around a central electrode such that there is a multiplicity of interstitial volumes. Each hollow fiber membrane 415a is positioned in a second interstitial volume 418. Sample is provided into and out of the first interstitial volumes by inlet means 440 and outlet means 445. Buffer or electrolyte is provided to the outer electrolyte zone 414 via inlet means 460 and outlet means 465. FIG. 4B shows an assembled view of the hollow fiber apparatus. The cylindrical housing 410 has a top end 420 and a bottom end 430.

In another form, the invention involves a hollow fibrae approach to electrophoresis, where one electrode in the shape of a thin wire is located at the center of a series of membranes, preferably concentric membranes, and a second electrode in the shape of a hollow cylinder is located outside the membranes.

Some variations on the apparatus include, but are not limited to:

i) Different electrode shapes, for example a cylindrical electrode, a flat strip electrode, an elliptical electrode, cross shaped electrode, or other shaped electrodes which allow beneficial manipulation of the electrical field.

ii) The third membrane can be excluded to create a system with two membranes for de-salting or dialysis applications where removal of contaminants is required.

iii) Multiple concentric membranes could be employed to effect simultaneous size based separations, for example concentric membranes with 50, 100, 200 etc. molecular weight cut-off values could be employed;

iv) Multiple separation tubes with separation channels each with membrane arrangements in a single separation unit define the arrangement of inner electrode, concentric membranes and outer electrode as a single tube or fibrae. Many of these fibers could be packed or bundled together in a single separation unit, with their outer electrolyte zones shared. The number of tubes in a bundle would be determined by the scale of separation or purification required. This type of arrangement of tubes or fibers in a bundle is seen in tissue culture bioreactors and artificial kidney devices.

v) Either an entire separation tube or fibrae, or a single membrane within a tube or fibrae could be spun around an axis defined by the inner electrode at an appropriate speed to create a centrifugal force effect on the samples within the fibrae. This centrifugal effect could be used to facilitate separations by including centrifugal force with electrophoretic effects, and could also be used for membrane de-fouling by spinning contaminants away from the outer faces of the containment or sieving membranes.

vi) The inner electrode can be rotated at the center of the apparatus to create periodic variations in the electric field intensity to facilitate separations which may benefit from such variations.

The uses suggested for this type of electrophoretic separation device include, but are not limited to: macromolecular separation or purification; micromolecular separation or purification; concentration by transfer from large sample volumes to smaller product volumes; de-salting by using a solvent with low ionic strength compared to the sample; concentration using a membrane composition that induces endo-osmotic flow from the sample to the solvent stream; hemodialysis for treatment of blood for the removal of disease related molecules; online extraction of biological products expressed in tissue culture/bioreactor systems; culture of cells within the hollow fibrae system, with the option of periodic product extraction and culture medium renewal/refreshment; use of immobilized affinity ligands attached the membranes for procedures requiring a combination of affinity and electrophoretic separations; and use of either free of immobilized enzymes or other catalysts in the sample stream to allow extraction of the reaction product as it is produced catalytically.

### EXAMPLES

Experiments were initiated to investigate electrophoresis separation using non-planar, particularly tubular membranes. A simple model system was prepared which demonstrated the function of the concentric membrane system.

Tubular membranes were prepared for the model system. Initially attempts were made to manufacture the membranes using an adaptation of a conventional membrane production scheme. Using an existing chemical system, acrylamide was cast onto tubular PET support using a variety of methods such as immersion, dip & roll, capillary action.

A different method was then investigated utilizing existing production of acrylamide electrophoresis membranes. Strips of polyacrylamide membranes were formed into tubes and sealed using a 1.5% agarose solution. The resulting membrane possessed sufficient mechanical strength to function in the model system as well as being able to hold liquid. Once the membranes had been manufactured they were used to construct the model system.

The experiment was designed around the primary concept of a device having concentric membranes as shown in FIG. 1A. The concept was very similar to conventional flat membrane-based electrophoresis technology with a three membrane ‘stack’ utilized. The major differences were the circular membranes, radial electric field produced between the electrodes and the static nature of the chambers formed by the membranes. The chambers were made static for reasons of experimental logistics rather than specific design.

The experiment carried out on the system was hemoglobin/coomassie-stained bovine serum albumin (BSA) separation routinely carried out in demonstrations of other electrophoresis technology. This separation was chosen as it provided visual feedback during the course of an electrophoretic run in the form of a color change in the zones or volumes between the membranes.

The results of the experiment were positive in that even from visual inspection the expected result partially occurred in that separation of the red and blue proteins occurred. SDS PAGE analysis of the experiments also indicated some selective transfer of the proteins had occurred.

Overall, the experiment provided a clear indication that the concentric membrane system works.

Conventional membrane electrophoresis technology is based on a flat-bed membrane configuration. The advantages of the present invention are the increase in available surface area, ability to use a plurality of streams or volumes between the membranes, and the mechanical strength associated with the cylindrical configuration.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Other features and aspects of this invention will be appreciated by those skilled in the art upon reading and comprehending this disclosure. Such features, aspects, and expected variations and modifications of the reported results and examples are clearly within the scope of the invention where the invention is limited solely by the scope of the following claims.

What is claimed is:

1. An electrophoresis apparatus comprising:
an inner electrode positioned in an inner electrolyte zone;
a substantially non-planar outer electrode positioned in an outer electrolyte zone, wherein the outer electrode in the outer electrolyte zone is disposed relative to the inner electrode in the inner electrolyte zone so as to be adapted to generate a radial electric field in an electric field area therebetween upon application of a selected electric potential between the inner and outer electrodes;
a first substantially non-planar membrane disposed in the electric field area;
a second substantially non-planar membrane disposed between the inner electrolyte zone and the first membrane so as to define a first interstitial volume therebetween, wherein the first interstitial volume is separated from the inner and outer electrolyte zones by the first and second membranes;
means adapted to communicate fluids to the inner electrolyte zone, the outer electrolyte zone, and the first interstitial volume; and
means adapted to provide a sample constituent to the first interstitial volume, wherein upon application of the electric potential at least one component in the sample constituent is caused to move through at least one membrane to an adjacent electrolyte zone.

2. The apparatus according to claim 1 further comprising means adapted to receive a selected voltage and means adapted to apply an electric potential corresponding thereto across at least the electric field area.

3. The apparatus according to claim 1 further comprising:
an elongated housing having first and second opposing ends and an interior portion containing the inner and outer electrodes and the membrane;
a first manifold positioned at the first opposing end of the housing, the first manifold having means adapted to communicate at least one associated fluid with at least one of the electrolyte zones and the interstitial volume; and
a second manifold positioned at the second opposing end of the housing, the second manifold having means adapted to communicate at least one associated fluid with at least one of the electrolyte zones and the interstitial volume.

4. The apparatus according to any one of claims 1 wherein the membranes are selected from the group consisting of electrophoresis membranes having defined pore sizes, charged membranes, electro-endo-osmosis membranes, and combinations thereof.

5. The apparatus according to claim 4 wherein the electrophoresis separation membranes are made from polyacrylamide and have a molecular mass cut-off of at least about 1 kDa.

6. The apparatus according to claim 4 wherein the charged membranes are selected from the group consisting of iso-electric membranes and amphoteric membranes

7. The apparatus according to claim 4 wherein the electro-endo-osmosis membranes are formed from the group consisting of cellulose tri-acetate membrane and polyvinyl alcohol.

8. The apparatus according to claim 1 further comprising a plurality of generally coaxial membranes disposed between the inner and outer electrolyte zones forming a plurality of interstitial volumes.

9. The apparatus according to claim 1 wherein the membranes are disposed in a non-planar shape selected from the group consisting of dish, u-shape, cone, oval, circular, and cylindrical.

10. An electrophoresis apparatus comprising:
an inner electrode positioned in an inner electrolyte zone;
a substantially non-planar outer electrode positioned in an outer electrolyte zone, wherein the outer electrode in the outer electrolyte zone is disposed relative to the inner electrode in the inner electrolyte zone so as to be adapted to generate a radial electric field in an electric field area therebetween upon application of an electric potential between the inner and outer electrodes;
a first substantially non-planar membrane disposed in the electric field area;
a second substantially non-planar membrane disposed between the inner electrolyte zone and the first membrane so as to define a first interstitial volume therebetween;
a third substantially non-planar membrane disposed between the outer electrolyte zone and the first membrane so as to define a second interstitial volume therebetween, wherein the first interstitial volume is separated from the inner electrolyte zone by the second membrane and the second interstitial volume is separated from the outer electrolyte zone by the third membrane;
means adapted to communicate fluids to the inner electrolyte zone, the outer electrolyte zone, the first interstitial volume and the second interstitial volumes; and
means adapted to provide a sample constituent to at least one of the interstitial volumes, wherein upon application of the electric potential at least one component in the sample constituent is caused to move through at least one membrane to an adjacent electrolyte zone or interstitial volume.

11. The apparatus according to claim 10 further comprising means adapted to receive a selected voltage and means adapted to apply an electric potential corresponding thereto across at least the electric field area.

12. The apparatus according to claim 10 further comprising:
an elongated housing having first and second opposing ends and an interior portion containing the inner and outer electrodes and the membrane;
a first manifold positioned at the first opposing end of the housing, the first manifold having means adapted to communicate at least one associated fluid with at least one of the electrolyte zones and the interstitial volume; and
a second manifold positioned at the second opposing end of the housing, the second manifold having means adapted to communicate at least one associated fluid with at least one of the electrolyte zones and the interstitial volume.

13. The apparatus according to any one of claims 10 wherein the membranes are selected from the group consisting of electrophoresis membranes having defined pore sizes, charged membranes, electro-endo-osmosis membranes, and combinations thereof.

14. The apparatus according to claim 13 wherein the electrophoresis separation membranes are made from polyacrylamide and have a molecular mass cut-off of at least about 1 kDa.

15. The apparatus according to claim 13 wherein the charged membranes are selected from the group consisting of iso-electric membranes and amphoteric membranes.

16. The apparatus according to claim 13 wherein the electro-endo-osmosis membranes are formed from the group consisting of cellulose tri-acetate membrane and polyvinyl alcohol.

17. The apparatus according to claim 10 further comprising a plurality of generally coaxial membranes disposed between the inner and outer electrolyte zones forming a plurality of interstitial volumes.

18. The apparatus according to claim 10 wherein the membranes are disposed in a non-planar shape selected from the group consisting of dish, u-shape, cone, oval, circular, and cylindrical.

19. An electrophoresis apparatus comprising:
an inner electrode positioned in an inner electrolyte zone;
a substantially non-planar outer electrode positioned in an outer electrolyte zone, wherein the outer electrode in the outer electrolyte zone is disposed relative to the inner electrode in the inner electrolyte zone so as to be adapted to generate a radial electric field in an electric field area therebetween upon application of a selected electric potential between the inner and outer electrodes;
at least one substantially tubular membrane disposed radially outward of an axis in the electric field area, wherein the inner electrode disposed generally along such axis, and wherein the tubular membrane has an exterior surface and an interior surface and the interior surface of the tubular membrane forms a first interstitial volume;
means adapted to communicate fluids to the inner electrolyte zone, the outer electrolyte zone, and the first interstitial volume; and
means adapted to provide a sample constituent to at least the first interstitial volume, wherein upon application of the electric potential at least one component in the sample constituent is caused to move through at least one membrane to an adjacent electrolyte zone.

20. The apparatus according to claim 19 further comprising:
a plurality of substantially tubular membranes disposed radially outward of an axis in the electric field area, wherein the inner electrode disposed generally along such axis, and wherein the tubular membranes have an exterior surface and an interior surface and the interior surface of each tubular membrane forms an interstitial volume; and
means adapted to communicate fluids to the interstitial volumes, wherein at least one of the fluids contains a sample constituent, and wherein upon application of the electric potential at least one component in the sample constituent is caused to move through at least one membrane to an adjacent electrolyte zone.

21. The apparatus according to claim 20 further comprising:
an elongated housing having first and second opposing ends and an interior portion containing the inner and outer electrodes and the membranes;
a first manifold positioned at the first opposing end of the housing, the first manifold having means adapted to communicate at least one associated fluid with at least one of the electrolyte zones and the interstitial volumes; and
a second manifold positioned at the second opposing end of the housing, the second manifold having means adapted to communicate at least one associated fluid with at least one of the electrolyte zones and the interstitial volumes.

22. The apparatus according to any one of claims 20 wherein the membranes are selected from the group consisting of electrophoresis membranes having defined pore sizes, charged membranes, electro-endo-osmosis membranes, and combinations thereof.

23. The apparatus according to claim 22 wherein the electrophoresis separation membranes are made from polyacrylamide and have a molecular mass cut-off of at least about 1 kDa.

24. The apparatus according to claim 22 wherein the charged membranes are selected from the group consisting of iso-electric membranes and amphoteric membranes.

25. The apparatus according to claim 22 wherein the electro-endo-osmosis membranes are formed from the group consisting of cellulose tri-acetate membrane and polyvinyl alcohol.

26. A method for concentrating or de-salting a sample constituent by electrophoresis comprising:
communicating fluids to an inner electrolyze zone and an outer electrolyte zone, wherein the inner and outer electrolyte zones each contain an electrode and the outer electrode is disposed relative to the inner electrode so as to be adapted to generate a radial electric field in an electric field area therebetween upon application of an electric potential between the inner and outer electrodes;
communicating a sample constituent to a first interstitial volume defined by a first substantially non-planar membrane disposed in the electric field area and a second substantially non-planar membrane disposed between the inner electrolyte zone and the first membrane, wherein the first interstitial volume is separated from the inner and outer electrolyte zones by the first and second membranes; and
applying a selected electric potential across at least the electric field area wherein upon application of the electric potential at least one component in the sample constituent is caused to move through at least one membrane to an adjacent electrolyte zone so as to obtain a treated sample in the first interstitial volume.

27. The method according to claim 26 further comprising collecting the treated sample from the first interstitial volume.

28. A method for concentrating or de-salting a sample constituent by electrophoresis comprising:
communicating fluids to an inner electrolyze zone and an outer electrolyte zone, wherein the inner and outer electrolyte zones each contain an electrode and the outer electrode is disposed relative to the inner electrode so as to be adapted to generate a radial electric field in an electric field area therebetween upon application of an electric potential between the inner and outer electrodes;
communicating fluids to at least one of the first interstitial volume and second interstitial volume, wherein the first interstitial volume is defined by a first substantially non-planar membrane disposed in the electric field area and a second substantially non-planar membrane disposed between the inner electrolyte zone and the first membrane, wherein the second interstitial volume is defined by the first membrane and a third substantially non-planar membrane disposed between the first membrane and the outer electrolyte zone, wherein the first interstitial volume is separated from the inner electrolyte zone by the second membrane and the second interstitial volume is separated from the outer electrolyte zone by the third membrane;
proving a sample constituent to at least one of the first and second interstitial volumes; and
applying a selected electric potential across at least the electric field are, wherein upon application of the electric potential at least one component in the sample constituent is caused to move through at least one membrane to an adjacent electrolyte zone or interstitial volume so as to obtain a treated sample in at least one of the first and second interstitial volumes.

29. The method according to claim 28 further comprising collecting the treated sample from at least one of the first and second interstitial volumes.

30. A method for concentrating or de-salting a sample constituent by electrophoresis comprising:
communicating fluids to an inner electrolyze zone and an outer electrolyte zone, wherein the inner and outer electrolyte zones each contain an electrode and the outer electrode is disposed relative to the inner electrode so as to be adapted to generate a radial electric field in an electric field area therebetween upon application of an electric potential between the inner and outer electrodes;
communicating a sample constituent to at least first interstitial volume disposed in the electric field area, wherein the first interstitial volume is defined by a substantially tubular membrane disposed radially outward of an axis in the electric field area, wherein the inner electrode disposed generally along such axis, and wherein the tubular membrane has an exterior surface and an interior surface and the interior surface forms the first interstitial volume; and
applying a selected electric potential across at least the electric field area wherein upon application of the electric potential at least one component in the sample constituent is caused to move through at least one membrane to an adjacent electrolyte zone so as to obtain a treated sample in the first interstitial volume.

31. A method for concentrating or de-salting a sample constituent by electrophoresis comprising:
communicating fluids to an inner electrolyze zone and an outer electrolyte zone, wherein the inner and outer electrolyte zones each contain an electrode and the outer electrode is disposed relative to the inner electrode so as to be adapted to generate a radial electric field in an electric field area therebetween upon application of an electric potential between the inner and outer electrodes;
communicating fluids to a plurality of interstitial volumes disposed in the electric field area, wherein the interstitial volumes are defined by a plurality of substantially tubular membranes disposed radially outward of an axis in the electric field area, wherein the inner electrode disposed generally along such axis, and wherein each tubular membrane has an exterior surface and an interior surface and the interior surface forms the interstitial volume; and
applying a selected electric potential across at least the electric field area wherein upon application of the electric potential at least one component in the sample constituent is caused to move through at least one membrane to an adjacent electrolyte zone so as to obtain a treated sample in at least one of the interstitial volumes.
